(19) United States
(12) Patent Application Publication
(10) Pub. No.: US 2006/0142677 A1
(43) Pub. Date: Jun. 29, 2006

(54) Versatile massage roller

(76) Inventor: Felipe C. Perez, Huntington Park, CA (US)

Correspondence Address: Wilson Daniel Swayze, Jr., 3804 Clearwater Ct., Plano, TX, 75025, US

(21) Appl. No.: 11/292,524

(22) Filed: Dec. 2, 2005

Related U.S. Application Data
(60) Provisional application No. 60/593,259, filed on Dec. 28, 2004.

(51) Int. Cl. A61H 15/00

(52) U.S. Cl. 601/120; 601/118; 601/125; 601/123; 601/135; 601/137

(57) ABSTRACT

A massage tool to enable people to speed up the massaging action in various parts of the human body and is convertible to one handle roller.

### PRIORITY

The present invention claims priority based on 35 USC section 119 and provisional patent application filed on Dec. 28, 2004, Ser. No. 60/593,259.

### FIELD OF THE INVENTION

The present invention relates to a massage roller.

### BACKGROUND OF THE INVENTION

The ability of one person to give a massage to another person has been limited by the absence of a device to provide a roller motion while giving a massage.

### SUMMARY

The present invention provides the ability of the first person to give a second person a massage.

The present invention allows the first person to use a device to give a roller motion to a second person.

The present invention allows the first person to use a versatile massage roller on a second person.

A versatile massage roller is constructed from articles without glue, screws or the like.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a cross-sectional view of the axle of the present invention;

FIG. 2 illustrates a cross-sectional view of the flexible sleeve of the present invention;

FIG. 3 illustrates a cross-sectional view of the first washer of the present invention;

FIG. 4 illustrates a cross-sectional view of the sleeve and axle of the present invention;

FIG. 5 illustrates a cross-sectional view of the second washer of the present invention;

FIG. 6 illustrates a cross-sectional view of the sleeve, axle and first and second washers of the present invention;

FIG. 7 illustrates a cross-sectional view of the handle sleeves placed on the axle;

FIG. 8 illustrates a cross-sectional view of a first end cap;

FIG. 9 illustrates a cross-sectional view of a second end cap;

FIG. 10 illustrates a cross-sectional view of the first end cap and the second end cap snapped in place;

FIG. 11 illustrates a cross-sectional view of the versatile massage roller assembled;

FIG. 12 illustrates a perspective view of the axle of the present invention;

FIG. 13 illustrates a perspective view of the first and second end caps;

FIG. 14 illustrates a perspective view of the soft and flexible sleeve;

FIG. 15 illustrates a side view of the soft and flexible sleeve;

FIG. 16 illustrates a perspective view of another end of the soft and flexible sleeve;

FIG. 17 illustrates a cross-sectional view of metallic washers;

FIG. 18 illustrates a perspective view of PVC sleeves;

FIG. 19 illustrates a cross-sectional view of the versatile massage roller;

FIG. 20 illustrates a cross-sectional view of a roller with two handles;

FIG. 21 illustrates a perspective view of the roller constructed with one handle;

FIG. 22 illustrates a cross-sectional view of the roller with no handles;

FIG. 23 illustrates another embodiment of the versatile massage roller of the present invention;

FIG. 24 illustrates another embodiment of the present invention;

FIG. 25 illustrates another embodiment of the present invention;

FIGS. 26-29 illustrates an end view of the sleeve of the present invention.

### DETAILED DESCRIPTION

The present invention includes a cylindrical axle which may be a PVC plastic pipe and may be approximately ½×17½ inches. The cylindrical axle may be metallic which may be heavier and more expensive. Additionally, the present invention includes a cylindrical sleeve being hollow and may be formed from expanded polystyrene with a hollow center which may be 2½×8 inches. The present invention may include two washers which may be metallic and which may be approximately ½×¾ inches to provide a resting point for the two handles. The handles may be formed from two cylindrical sleeves which may be PVC plastic pipe and may be ¾×4 inches to provide the roller motion when forced against the cylindrical axles. Additionally, the present invention includes two pipe caps which may be formed from PVC plastic and which may be ½ inches to keep the handles in place and provide a resting point for the handles.

The axle holds the various components of the versatile massage roller. The cylindrical sleeves are positioned at the center of the axle. The two washers are inserted over the axle; one washer on each side against the soft sleeve. Each of the two handles is inserted at each end over the axle, and the caps are inserted at each end to complete the massage roller by holding the handles on the axle.

As a force is applied to each of the two handles by a first user, the axle rotates, and the rolling motion of the whole body of the massage roller including the soft sleeve to a muscle or muscles of a second user generates a stimulating sensation by increasing circulation and muscle relaxation. Additionally, the massage roller provides the related benefits of a massage.

While the above description has been in terms of a two handle roller, the teachings of the present invention may be applied equally to a one handle roller to reach various angles of the neck. The circumferences and lengths may be varied to accommodate different sizes of the massage roller, for example small, medium and large sizes.

A first user may use the massage roller to massage a second user, or the first user may use the massage roller on his/her self by placing the massage roller on a hard surface, for example the floor or the wall, and using motion over the massage roller to obtain the massage effect. Additionally, the first user may lie over the massage roller and remain still until the first user feels that he/she has obtained the relief desired.

The massage roller of the present invention may be used to massage the back, legs, arms, especially the palms of the hands and the inner parts of the feet, resulting in a very soothing effect. The benefits of the massage roller of the present invention include relaxation and improve circulation.

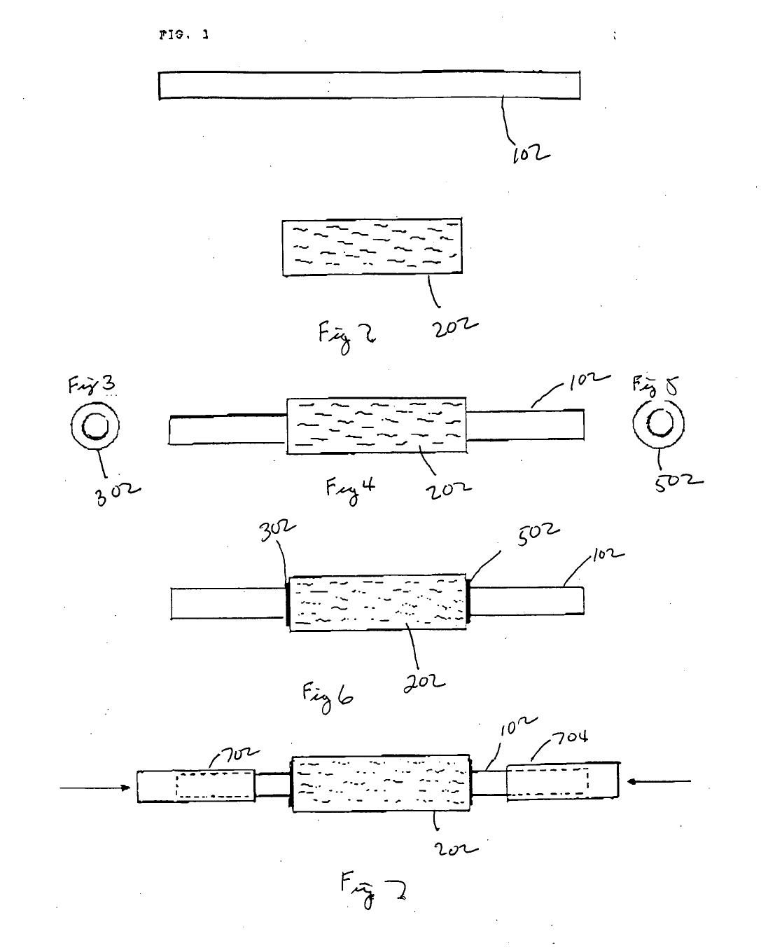

FIG. 1 illustrates a cross-section of the axle 102 to be used with the massage roller.

FIG. 2 illustrates the soft and flexible sleeve 202 to be used with the massage roller. The sleeve 202 may be formed from expanded polystyrene.

FIG. 3 illustrates a first washer 302 to be used with the massage roller.

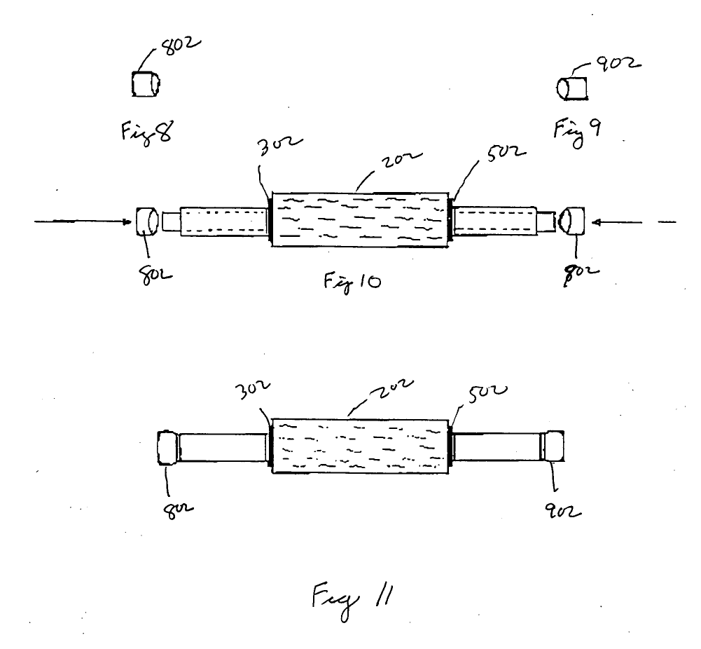

FIG. 4 illustrates the axle 102 in the flexible sleeve 202 assembled.

FIG. 5 illustrates a second washer 502 to be used with the massage roller.

FIG. 6 illustrates the flexible sleeve 202 mounted on the axle 102 and with the first washer 302 and the second washer 502 positioned adjacent to the flexible sleeve 202 which is positioned in the approximate center of the axle 102.

FIG. 7 illustrates the first handle 702 and the second handle 704 being inserted on the axle 102.

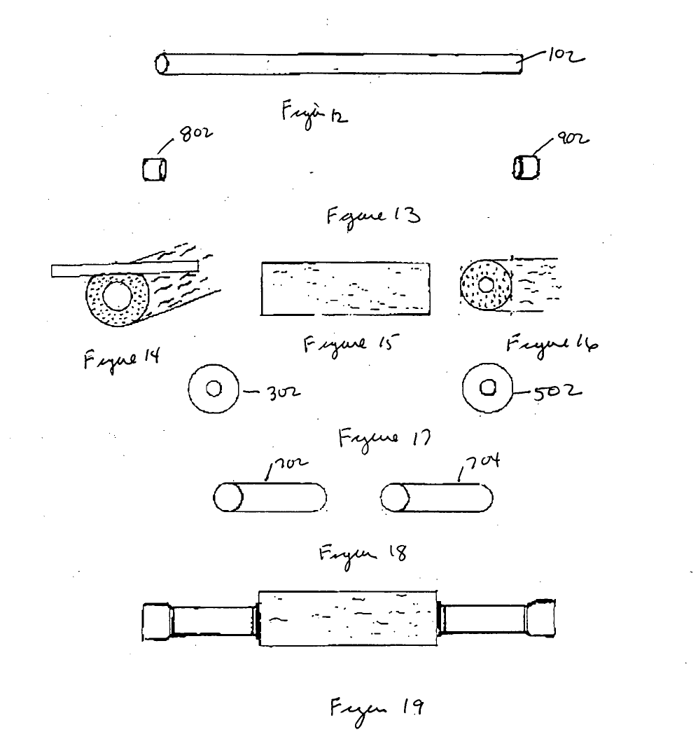

FIG. 8 illustrates a first end cap 802, and FIG. 9 illustrates a second end cap 902.

FIG. 10 illustrates the first end cap 802 being inserted on one end of the axle 102, and the second end cap 902 being inserted on the other end of the axle 102.

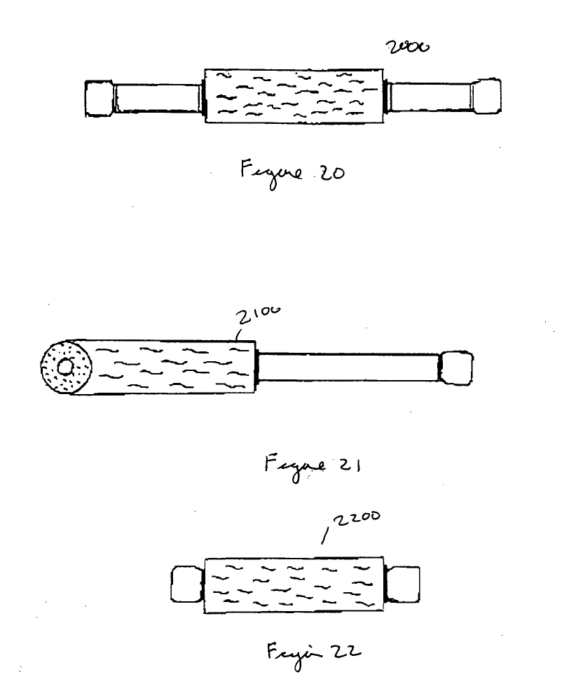

FIG. 11 illustrates the versatile massage roller 1100 assembled in accordance with the teachings of the present invention. The first end cap 802 is positioned adjacent to the first handle 702 while the second end cap 902 is positioned adjacent to the second handle 704. It should be noted that no glue or screws is required to assemble the present invention. A friction fit or pressure and snap on action holds the present invention together. However, glue or screws could be used to assemble the present invention.

FIG. 12 illustrates a perspective view of the PVC axle 102 which may be ½ by 17½ inches.

FIG. 13 illustrates a perspective view of the first end cap 802 and the second end cap 902 which may be made from ½ inch PVC.

FIG. 14 illustrates a perspective view of one end of the soft and flexible sleeve 202 which may be formed from expanded polystyrene.

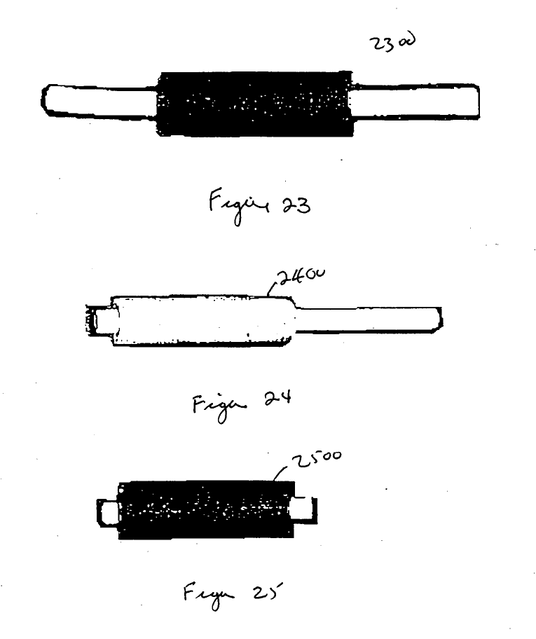

FIG. 15 illustrates a side view of the flexible sleeve 202, and FIG. 16 illustrates a perspective view of the other end of the flexible sleeve 202.

FIG. 17 illustrates a side view of the first washer 302 and the second washer 502 which may be formed from metal.

FIG. 18 illustrates a perspective view of the first handle 702 and the second handle 704 which may be formed from ¾×4 inch PVC sleeves.

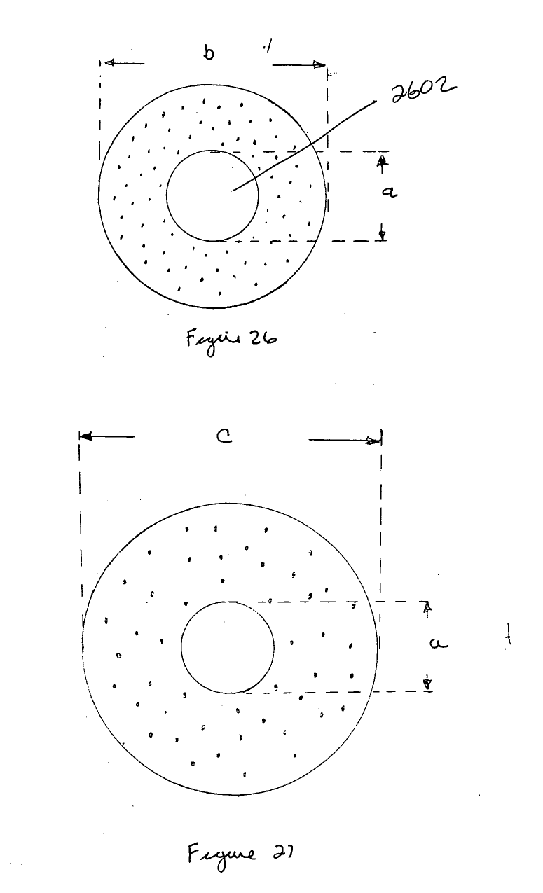

FIG. 19 illustrates a side view of the finished product of the versatile massage roller.

FIG. 20 illustrates a roller 2000 with two handles.

FIG. 21 illustrates a roller 2100 with one handle.

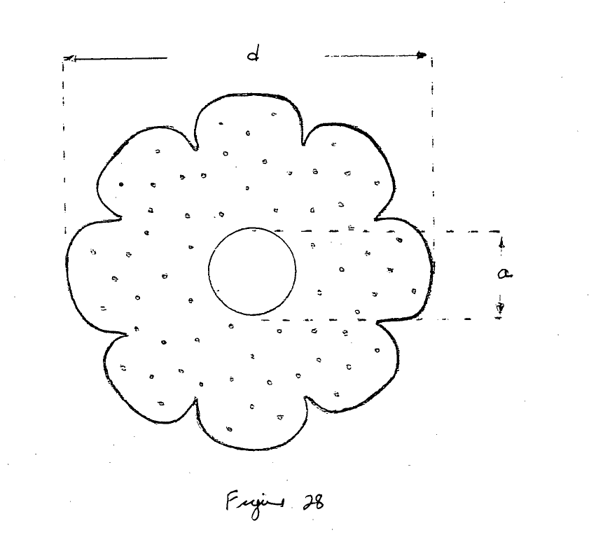

FIG. 22 illustrates a roller 2200 with no handles but with end caps.

FIG. 23 illustrates a roller 2300 with handles and end caps.

FIG. 24 illustrates a roller 2400 with a single handle on one end and a single end cap on the other end. Since the handles and end caps are not permanently attached to the axle, the handles and end caps can be removed and reconfigured to any of the rollers shown in the drawings.

FIG. 25 illustrates a roller 2500 with no handles but with end caps.

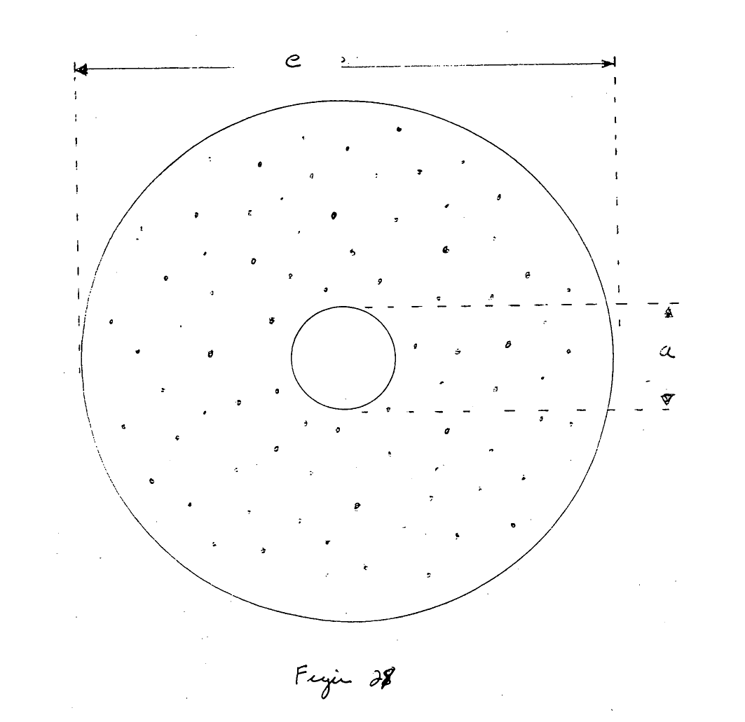

FIG. 26 illustrates an end view of the sleeve 202 having a hole 2602 for the axle 102. The diameter of the hole 2602 is shown as element a which may be ⅞ inch. The diameter of the sleeve 202 is shown as element b which may be 2⅛ inch.

FIG. 27 illustrates an end view of another embodiment of the sleeve 202. FIG. 27 shows the diameter of the sleeve 202 as element c which may be 2¾ inches.

FIG. 28 illustrates an end view of another embodiment of the sleeve 202 which shows the diameter of the sleeve as element d which may be 3⅜ inches.

FIG. 29 illustrates an end view of another embodiment of the sleeve 202 shows the diameter of the sleeve as element e which may be 5 inches.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1. A massage device to be rolled over a portion of a body to be massaged, comprising:
a cylinder that can be manipulated by a person being massaged.

2. A massage device to be rolled over a portion of a body to be massaged as in claim 1, wherein said device includes a handle.

3. A massage device to be rolled over a portion of a body to be massaged as in claim 1, wherein said device includes a flexible sleeve.

4. A massage device to be rolled over a portion of a body to be massaged as in claim 1, wherein said device includes a shaft.

5. A massage device to be rolled over a portion of a body to be massaged as in claim 1, wherein said device includes an end cap.

6. A massage device to be rolled over a portion of a body to be massaged as in claim 1, wherein said device includes only one handle.

7. A massage device to be rolled over a portion of a body to be massaged as in claim 1, wherein said device includes only one end cap.

8. A massage device to be rolled over a portion of a body to be massaged as in claim 1, wherein said device is convertible from a one handle device to a two handle device.

9. A massage device to be rolled over a portion of a body to be massaged as in claim 1, wherein said device is convertible from a two handle device to a one handle device.
